(19) United States
(12) Patent Application Publication
(10) Pub. No.: US 2015/0038884 A1
(43) Pub. Date: Feb. 5, 2015

(54) Magnetically Assisted Dermatological Treatment Method

(71) Applicants: Hansel M. DEBARTOLO, JR., Sugar Grove, IL (US); Nick Scott GONZALES, Pueblo, CO (US)

(72) Inventors: Hansel M. DEBARTOLO, JR., Sugar Grove, IL (US); Nick Scott GONZALES, Pueblo, CO (US)

(21) Appl. No.: 13/955,873

(22) Filed: Jul. 31, 2013

(51) Int. Cl. A61H 7/00

(52) U.S. Cl. CPC A61H 7/00
USPC 601/19

(57) ABSTRACT

A magnetically assisted dermatological treatment method incorporates a pre-treatment protocol, a magnetically assisted dermatological procedure, and a post treatment protocol in order to assist in the displacement of magnetically active pigments trapped between the dermis and epidermis layers of a patient's skin. The method utilizes the pre-treatment protocol to condition the patient's skin, loosening up the pigments that are trapped between the dermis and the epidermis through magnetically assisted means. After which, a laser photothermolytic procedure is administered by a magnetically assisted light emitting apparatus which attracts and dislodges pigments absorption and magnetic properties. Finally, after the laser phototherapy, the patient's treated area undergoes a post treatment protocol which assists in the healing and recovery process while additionally assisting in preventing the pigments from becoming trapped again within the dermis and epidermis layers.

### FIELD OF THE INVENTION

The present invention relates generally to a treatment method, more specifically to a dermatological treatment method that utilizes a magnetically assisted dermatological procedure for the purpose of removing tattoos and various pigment based dermatological conditions.

### BACKGROUND OF THE INVENTION

It is well known to dermatologist and plastic/cosmetic surgeons that the success of removing a tattoo from a patient's body is highly dependent on several factors. These factors are largely due to the composition of the tattoo inks and the manner in which the tattoos are administered into the dermal tissue of the patient's skin. Generally, tattoos are injected into the dermis layer of a patient's skin through the use of a needle. After insertion into the dermal layer, the tattoo ink spreads and activates an immune response which holds the tattoo pigments in the dermis layer. Over time the tattoo pigments become trapped in the upper dermis concentrating between the boundary of the dermis and the epidermis. The positioning of the tattoo pigment on the boundary between the dermis and the epidermis makes removal difficult since each removal attempt would need to disrupt the positioning of the pigments. Although some pigments may be removed by the lymphatic system, many would find themselves partially displaced and not completely removed leaving them susceptible to the same immune response that initially held them in place between the dermis and the epidermis. In many cases dispersed pigments may migrate only be temporarily dispersed to only. Although the removal of tattoos is difficult, one particular method has shown to have consistently favorable results.

The particular method in question is the use of a laser phototherapy. Laser phototherapy is a photothermolytic therapy that focuses a beam of light onto the area of the patient's skin coincident with the tattoo and focuses the light on the pigments. The pigments absorb the beam converting the energy as heat. The heat converted by the pigments dislodges the pigments from their location between the dermis and epidermis but additionally breaks up masses of the pigment into smaller, more manageable particles that are removed by the patient's lymphatic system. Although laser photo therapies are effective at removing most tattoos they do suffer from some short comings. These short comings are normally associated with the reliance on the tattoo inks having an optical absorption that is lower than that of the surrounding tissue. If the tattoo inks are unable to absorb light energy effectively, they will be unable to convert the light energy into heat resulting in them being dislodging from their position between the dermis and the epidermis.

It is therefore the object of the present invention to provide a magnetically assisted dermatological treatment method incorporates a pre-treatment protocol, a magnetically assisted dermatological procedure, and a post treatment protocol in order to assist in the displacement of magnetically active pigments trapped between the dermis and epidermis layers of a patient's skin. The method utilizes the pre-treatment protocol to condition the patient's skin, loosening up the pigments that are trapped between the dermis and the epidermis through magnetically assisted means. After which, a laser photothermolytic procedure is administered by a magnetically assisted light emitting apparatus which attracts and dislodges pigments absorption and magnetic properties. Finally, after the laser phototherapy, the patient's treated area undergoes a post treatment protocol which assists in the healing and recovery process while additionally assisting in preventing the pigments from becoming trapped again within the dermis and epidermis layers.

### BRIEF DESCRIPTIONS OF THE DRAWINGS

FIG. 1 is a block diagram displaying the process overview of the current embodiment of the present invention.

FIG. 2 is a block diagram displaying the steps that comprise the step of evaluating the patient seeking the magnetically assisted dermatological treatment regimen.

FIG. 3 is a block diagram displaying the steps that comprise the step of initiating the pre-treatment protocol.

FIG. 4 is a block diagram displaying the steps that further comprise the step of administering the pre-treatment protocol as per an embodiment of the present invention.

FIG. 5 is a block diagram displaying the steps that further comprise the step of administering the pre-treatment protocol as per another embodiment of the present invention.

FIG. 6 is a block diagram displaying the steps that further comprise the step of administering the pre-treatment protocol as per yet another embodiment of the present invention.

FIG. 7 is a block diagram displaying the steps that comprise the step of administering the treatment session of the magnetically assisted dermatological procedure.

FIG. 8 is a block diagram displaying the steps that comprises the step of initiating the post-treatment protocol.

FIG. 9 is a block diagram displaying the steps that further comprise the step of administering the post-treatment protocol as per an embodiment of the present invention.

FIG. 10 is a block diagram displaying the steps that further comprise the step of administering the post-treatment protocol as per another embodiment of the present invention.

FIG. 11 is a block diagram displaying the steps that further comprise the step of administering the post-treatment protocol as per yet another embodiment of the present invention.

FIG. 12 is a block diagram displaying the steps that comprise the step of reevaluating the patient after the post-treatment protocol.

### DETAIL DESCRIPTIONS OF THE INVENTION

All illustrations of the drawings are for the purpose of describing selected versions of the present invention and are not intended to limit the scope of the present invention.

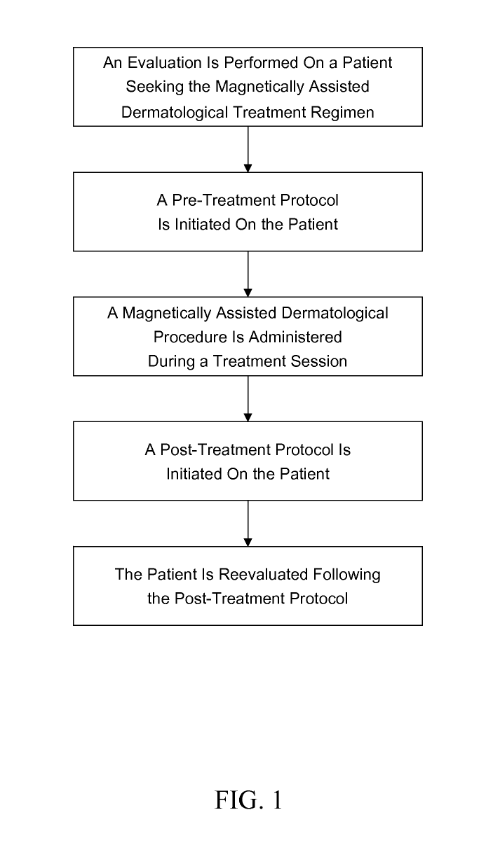

Referencing FIG. 1, the magnetically assisted dermatological treatment regimen is a method that primarily serves as a means of removing tattoos from a patient's dermis, as well as the ability of resolving various dermatological conditions, such as port wine stains and freckles. The method is provided with three stepwise processes that consist of a pre-treatment protocol, a magnetically assisted dermatological procedure, and a post treatment protocol. The pre-treatment protocol functions as a process for conditioning a patient's treatable area, in order to ensure success of the magnetically assisted dermatological procedure. The magnetically assisted dermatological procedure is a laser phototherapy procedure that utilizes a magnetically assisted light emitting apparatus in as the instrument that removes ferrous containing dyes or stains that comprise the patient's dermatological condition. The post-treatment protocol is provided as a recovery process that helps the healing as well as provides a mean of further improving treatment success. In the current embodiment of the present invention, the magnetically assisted dermatological treatment regimen comprises the steps of evaluating the patient seeking a magnetically assisted dermatological treatment regimen; initiating a pre-treatment protocol; administering a treatment session of the magnetically assisted dermatological procedure; initiating the post-treatment protocol; and reevaluating the patient after the post-treatment protocol. It should be noted that the magnetically assisted dermatological treatment regimen is herein after referred to as the treatment regimen unless otherwise noted. Furthermore it should be noted that the magnetically assisted dermatological procedure is hereinafter referred to as the procedure, unless otherwise noted.

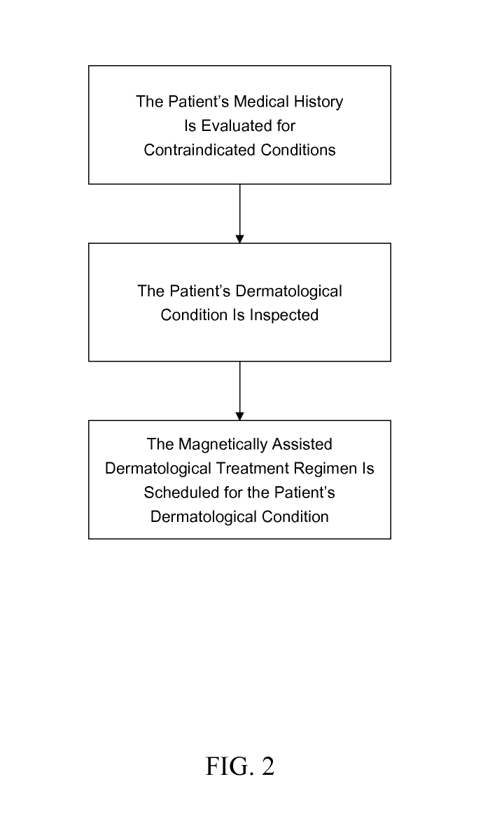

Referencing FIG. 1 and FIG. 2, the evaluation of the patient seeking the magnetically assisted treatment regimen is provided as a means of determining the patient's eligibility of the treatment, the success of the treatment based on the patient's dermatological condition. In addition to determining the patient's eligibility, the evaluation step further provides determinant steps for selecting a pre-treatment protocol, and a post-treatment protocol that is optimally suited for resolving the patient's dermatological condition, as well as scheduling the treatment session of the magnetically assisted dermatological procedure for the patient's dermatological condition. In the current embodiment of the present invention, the steps of evaluating the patient seeking the magnetically assisted dermatological treatment regimen comprises the steps of evaluating the patient's medical history for contraindicated conditions; inspecting the patient's dermatological condition; determining the pre-treatment protocol for the patient's dermatological condition; scheduling the a treatment session of the magnetically assisted dermatological procedure for the patient's dermatological condition; and determining the post treatment protocol for the patient's dermatological condition.

Referencing FIG. 1 and FIG. 2, the evaluation of the patient's medical history determines the patient's eligibility for the treatment regimen based on the patient's preexisting medical conditions. The patient medical history is specifically evaluated to determine if any of the preexisting medical conditions are contraindicated condition which would have a high likelihood of causing complications or unwanted interactions during or after the procedure or treatment regimen. The inspection of the patient's dermatological condition determines the possible effectiveness of the procedure, as well as, length of treatment regimen, and any adjustment that would have to be made to accommodate a patient's dermatological condition. The patient's dermatological condition is generally understood as a section of the patient's dermis that contains either a tattoo, port wine stain, or a plurality freckles that are capable of being removed through the administration of the treatment regimen. It should be noted that the inspection step would evaluate the patient's tattoo ink for the presence of ferrous based ink dyes in order to determine how if the patient's tattoo is capable of being removed. Furthermore, the inspection step utilizes the size and positioning of the patient's dermatological condition in order to determine the length of the treatment regimen. The scheduling of the magnetically assisted dermatological treatment regimen utilizes the information obtained from the inspection of the patient's dermatological condition in order to provide sufficient time for the pre-treatment protocol, the magnetically assisted dermatological procedure, and the post-treatment protocol in order to resolve the patient's dermatological condition. The scheduling process takes into account the size, location, and type of the patient's dermatological condition in order to provide sufficient time for the pre-treatment protocol to effectively prepare the patient's treatable area prior to the administration of the magnetically assisted dermatological procedure. Additionally the scheduling process is used to provide the appropriate amount of treatment sessions of the magnetically assisted dermatological procedure in order to adequately resolve the patient's dermatological condition. Furthermore, the scheduling process ensures the scheduling of the post-treatment protocol and the patient reevaluation step.

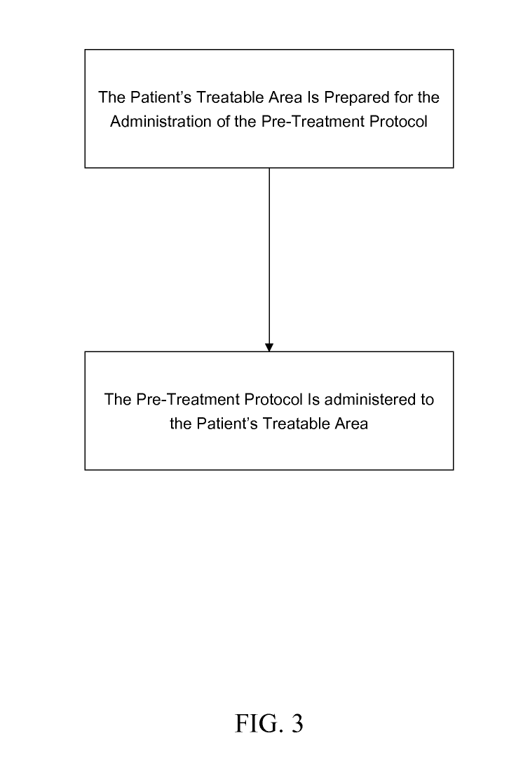

Referencing FIG. 1 and FIG. 3, the initiation of the pre-treatment protocol is a provided as a conditioning step that prepares a patient's treatable area for the administration of the treatment session of the magnetically assisted dermatological procedure. The initiation of the pretreatment protocol is provided with the understanding that the patient's dermatological condition is a treatable area. In the current embodiment of the present invention the step of initiating the pre-treatment protocol comprises the steps of preparing the patient's treatable area for administration of the pre-treatment protocol, followed by administering the pre-treatment protocol to the patient's treatable area. The preparation of the patient's treatable area is provided as a step that improves the effectiveness of pre-treatment protocol by cleaning and shaving the area immediately coincident the patient's treatable area. The administration of the pre-treatment protocol to the patient's treatable area is the conditioning step that helps.

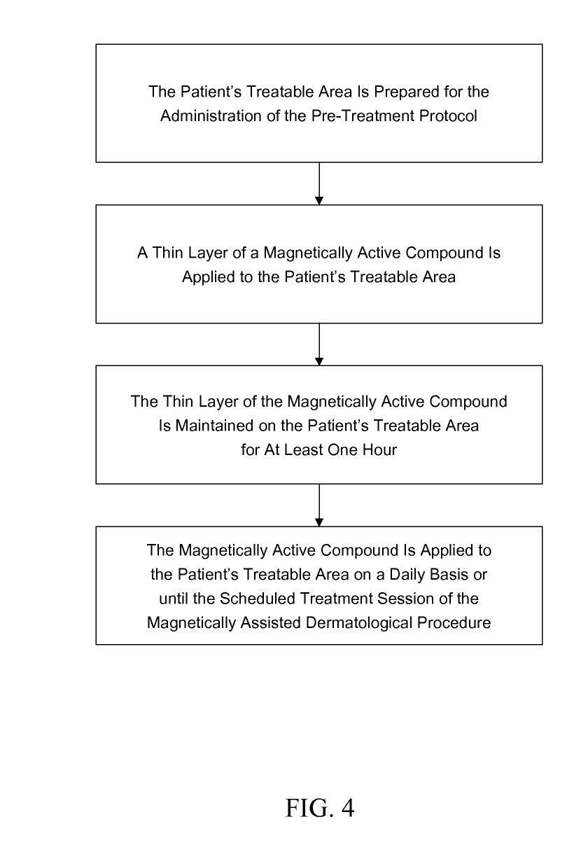

Referencing FIG. 3 and FIG. 4, in one embodiment of the present invention, the pre-treatment protocol comprises the steps of applying a thin layer of a magnetically active compound to the patient's treatable area; maintaining the thin layer of the magnetically active compound on the patient's treatable area for at least one hour; and repeating the actions of applying the thin layer of the magnetically active compound on the patient's treatable area for at least one hour, on a daily basis, until the scheduled treatment session of the magnetically assisted dermatological procedure. The magnetically active compound would be placed over the patient treatable area permitting the magnetically active compound to attract iron oxides commonly found in tattoos. The magnetically active compound is placed on the patient's treatable area for a period of at least one hour. The magnetically active compound is placed on the treatable area on a daily basis until the day of the scheduled treatment session of the magnetically assisted dermatological procedure. In the current embodiment, the magnetically active compound is provided as a negatively charged compound contains detoxifying properties. In the preferred embodiment of the present invention the magnetically active compound is provided aluminium phyloosilicate paste which is alternatively known as bentonite clay.

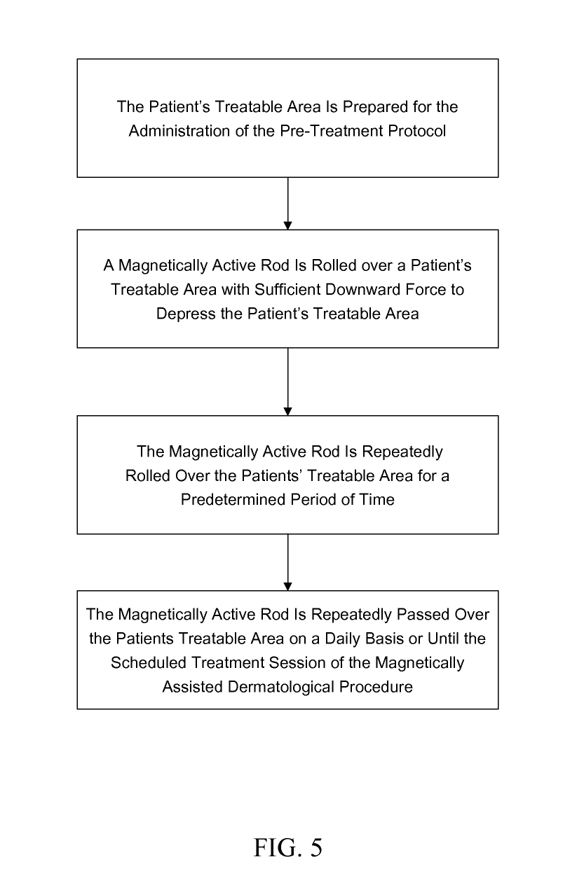

Referencing FIG. 3 and FIG. 5, in another embodiment of the present invention, the administration of the pre-treatment protocol utilizes a magnetically active rod. The magnetically active rod is utilized in the pre-treatment protocol as a means of mechanically stimulating the patient's treatable area. The pre-treatment protocol comprises the steps of rolling the magnetically active rod over the patient's treatable area with sufficient downward force to depress the patients' treatable area; repeating the action of rolling the magnetically active rod over the patient's treatable area for a predetermined period of time; and repeating the action of the passing the magnetically active rod over the patient's treatable area for a predetermined period of time on a daily basis until the date of the scheduled treatment session of the magnetically assisted dermatological procedure. The magnetically active rod is provided as a means of mechanically depressing the patient's treatable area disrupting the positioning of magnetically active pigments or dyes that are found in the treatable area. By repeatedly rolling the magnetically active rod over the treatable area for a predetermined period of time, a larger quantity of magnetically active pigments and dyes can be loosened up facilitating the removal through the magnetically assisted dermatological procedure. It should be noted that the predetermined period of time would be a provided value associated with the size and location of the patient's treatable area. It should be noted that the magnetically active rod may be constructed using integrally positioned rare earth magnets, such as neodymium magnets, but could additionally utilize an electromagnet.

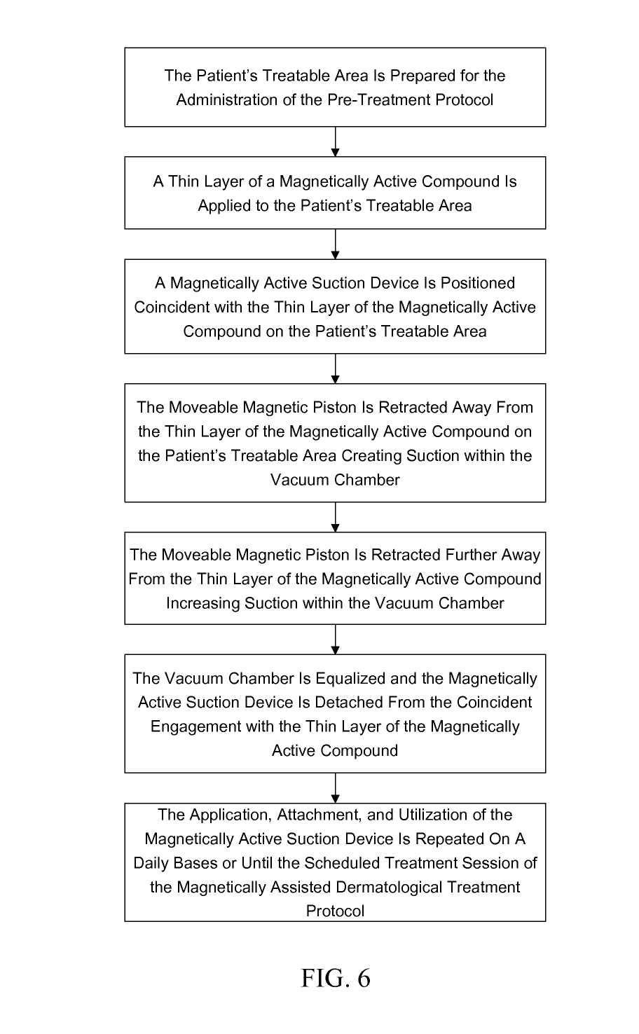

Referencing FIG. 3 and FIG. 6, still in another embodiment of the present invention, the pre-treatment protocol utilizes a magnetically active suction device in combination with the magnetically active compound as a means of conditioning the patient's treatable area for administration of the magnetically assisted dermatological procedure. The magnetically active suction device comprises a vacuum chamber and a moveable magnetic piston. The vacuum chamber is the interior portion of the magnetically active suction device that increases or decreases in pressure depending on the positioning of the moveable magnetic piston. The moveable magnetic piston functions as a plunger that is sleeved by the inner walls of the vacuum chamber forming an air tight seal. When the vacuum chamber is sealed, the moveable magnetic piston creates an area of negative pressure when retracted within vacuum chamber. It should be noted that the moveable magnetic piston is held in place when retracted through a nonspecific mechanism within the magnetically active suction device which could be accomplished. The administration of the pre-treatment protocol comprises the steps of applying a thin layer of the magnetically active compound to the patient's treatable area; positioning the magnetically active suction device coincident with the thin layer of the magnetically active compound on the patient's treatable area; creating a suction in the vacuum chamber by retracting the moveable magnetic piston away from the thin layer of the magnetically active compound on the patient's treatable area; increasing the suction within the vacuum chamber by retracting the moveable magnetic piston further from the thin layer of the magnetically active compound on the patient's treatable area; removing the magnetically active suction device from the coincident positioning with the thin layer of the magnetically active compound on the patient's treatable area after a predetermined period of time; repeating the above actions on a daily basis until the scheduled treatment session of the magnetically assisted dermatological procedure.

Referencing FIG. 3 and FIG. 6, the application of the thin layer of the magnetically active compound on the patient's treatable area is provided as a magnetic compound and as a sealant for securing the magnetically active suction device to the patient's treatable area. The magnetically active suction device is positioned coincident with the magnetically active compound on the patient's treatable area forming an air tight seal for the vacuum chamber. The creation of suction within the vacuum chamber occurs upon retracting the moveable magnetic piston further into the vacuum chamber. The moveable magnetic piston is retracted away from the magnetically active compound positioned on top of the patient's treatable area resulting in an area of negative pressure forming within the vacuum chamber. It should be noted that in the current embodiment of the present invention, the moveable magnetic piston utilizes a rare-earth magnet that is provided with the north side facing towards the thin layer of the magnetically active compound on the patient's treatable area, but that in additional embodiments, the moveable magnetic piston could potentially utilize an electromagnet in the same capacity. After suction is created within the vacuum chamber, the magnetically active suction device is maintained on the patient's treatable area for a predetermined period of time, wherein the predetermined period of time is approximately a 10 minute interval. Upon completion of the predetermined period of time, the negative pressure within the suction chamber is increased by further retracting the moveable magnetic piston within the vacuum chamber. The suction within vacuum chamber is increased several times during the administration of the pre-treatment protocol after which the pressure within the vacuum chamber is equalized and the magnetically active suction device is removed from its position coincident with the thin layer of the magnetically active compound on the patient's treatable area. The administration of the pre-treatment protocol is repeated on a daily basis until the date of the scheduled magnetically assisted dermatological procedure. It should be noted that while the magnetically active suction device, in the additional embodiment, utilizes a moveable magnetic piston, that in an alternative embodiment, the moveable magnetic piston can be omitted providing the magnetically active suction device as any suction device or system that generates suction within the vacuum chamber.

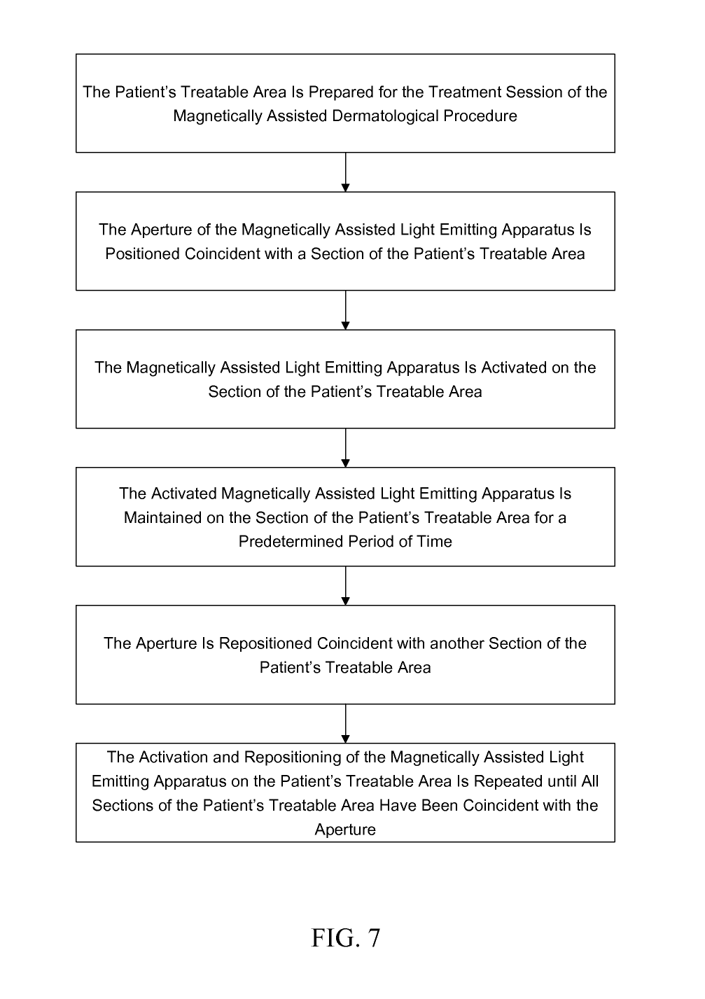

Referencing FIG. 1 and FIG. 7, the administration of the magnetically assisted dermatological procedure treatment session, attempts to resolve the patient dermatological condition through the use of a magnetically assisted light emitting apparatus. The magnetically assisted light emitting apparatus is a laser phototherapy instrument that principally comprises an aperture that emits the light becomes coincident with the patient's dermatological condition and a magnetically active ring to assist in the resolution of the patient's dermatological condition. The magnetically active ring functions by attracting magnetically active compounds that are released by upon administration of the light form to the patient's treatable area. The magnetically ring is positioned near the aperture in a manner which encircles the portion of the aperture that becomes coincident with the patient's treatable area. The step of administering the magnetically assisted dermatological treatment is provided with the understanding that the patients' dermatological condition is a treatable area that is subdivided into sections. In the current embodiment of the present invention, the administration of a treatment session of the magnetically assisted dermatological procedure further comprises the steps of preparing the patient's treatable area for the treatment session of the magnetically assisted dermatological procedure; positioning the aperture coincident with a section of the patient's treatable area; activating the magnetically assisted light emitting apparatus on the section of the patient's treatable area; maintaining the activated magnetically assisted light emitting apparatus on the section of the patients' treatable area for a predetermined period of time; repositioning the aperture coincident with another section of the patient's treatable area; and repeating the actions of activating the magnetically assisted light emitting apparatus on the section of the patient's treatable, maintaining the magnetically assisted light emitting apparatus on the patient's treatable area on the predetermined period of time, and a repositioning the aperture coincident with another section of the patient's treatable area until all sections of the patient's treatable area have been coincident with the aperture.

Referencing FIG. 1 and FIG. 7, the preparation of the patients' treatable area during the administration of the treatment session is provided as a necessary step in order to reduce chances of infection to the patient's treatable area as well as reducing debris ejected during the magnetically assisted dermatological procedure. The preparation step consists of cleaning and sterilizing the patient's treatable area as well as removing any reflective material that is positioned in close proximity to the patient's treatable area. After the treatable area has been prepared, the magnetically assisted light emitting apparatus is brought into alignment positioning the aperture coincident with a section of the patient's treatable area. With the aperture in position, the magnetically assisted light emitting apparatus is activated producing a beam of light which thermolytically disrupts the patient's tissue that is coincident with the aperture. Concurrently, the magnetically active ring encircling the aperture assists in disrupting magnetic compounds that are found in the patient's tissue by attracting them towards the surface. The activated magnetically assisted light emitting apparatus is maintained on the section of the patient's treatable are for a predetermined period of time, wherein the predetermined period of time is provided with a range of 10 to 45 seconds or until the patient feel a good burn or snap. After the predetermined period of time, the aperture is repositioned to be coincident with another section of the patient's treatable area. With the aperture repositioned, the steps of activating the light emitting apparatus, maintaining the light emitting apparatus on the patients' treatable area for a predetermined period of time, and then repositioning the aperture on another section of the patient's treatable area are repeated until all sections of the patient's treatable area have been coincident with the aperture. Once all the sections of the patient's treatable area have been coincident with the aperture of the activated magnetically assisted light emitting apparatus, the patient's treatable area is provided as the patient's treated area.

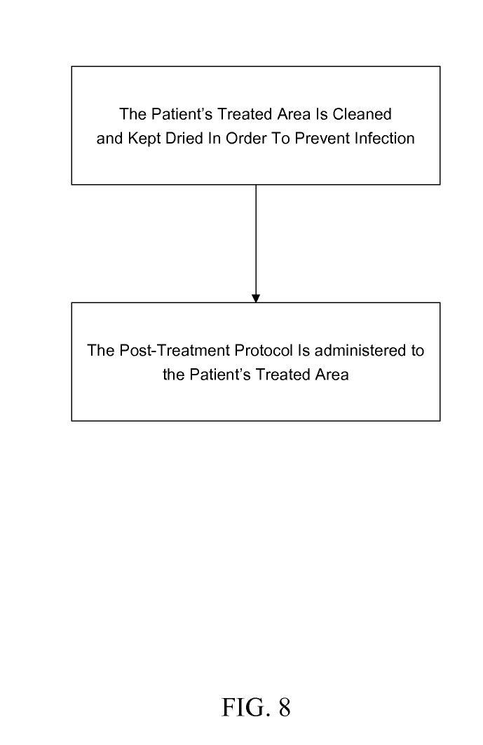

Referencing FIG. 1 and FIG. 8, the initiation of the post-treatment protocol occurs following the administration of a treatment session of the magnetically assisted dermatological procedure. The post treatment protocol is provided as a recovery process that improves resolution of the magnetically assisted dermatological procedure by aiding in the healing process and reducing the risk of unwanted reactions and complication that can occur following a treatment session. The administration of the post-treatment protocol is similar to the pre-treatment protocol and in some cases is almost identical due to the post-treatment protocol serving as an intermediary step between treatment sessions of the magnetically assisted dermatological procedure. The step of initiating the post-treatment protocol is provided with the understanding that the patient's dermatological condition is considered the treated area following the administration of the treatment session. Furthermore, the step of initiating the post-treatment protocol is provided with the understanding that the post-treatment protocol precedes a scheduled reevaluation session of the patient's treated area. In the current embodiment of the present invention, the post-treatment protocol comprises the steps of maintaining the treated area clean and dry to prevent infection; and administering the post-treatment protocol to the patient's treated area. It should be noted that the post-treatment protocol can include the administration of an orally administered compound that assists in flushing out the dislodged dyes and pigments. The orally administered compounds that assist in flushing out the dislodged dyes include but are not limited to flush-free niacin as well as any other flushing agents that will bind to the dislodged pigments and dyes in order to remove them from the body.

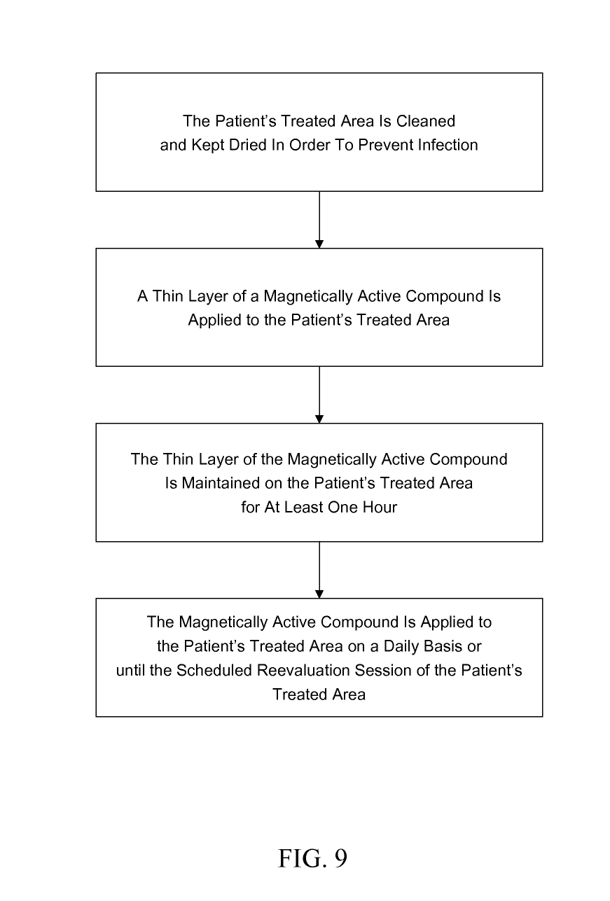

Referencing FIG. 8 and FIG. 9, in an embodiment of the present invention, the post-treatment protocol comprises the steps of applying a thin layer of a magnetically active compound to the patient's treated area; maintaining the thin layer of the magnetically active compound on the patient's treated area for at least one hour; and repeating the actions of applying the thin layer of the magnetically active compound on the patient's treated area for at least one hour, on a daily basis, until the scheduled reevaluation session. The magnetically active compound would be placed over the patient's treated area permitting the magnetically active compound to attract magnetic compound dislodged during the administration of the magnetically assisted dermatological procedure. The magnetically active compound is placed on the patient's treated area for a period of at least one hour. The magnetically active compound is placed on the treatable area on a daily basis until the day of the scheduled reevaluation session.

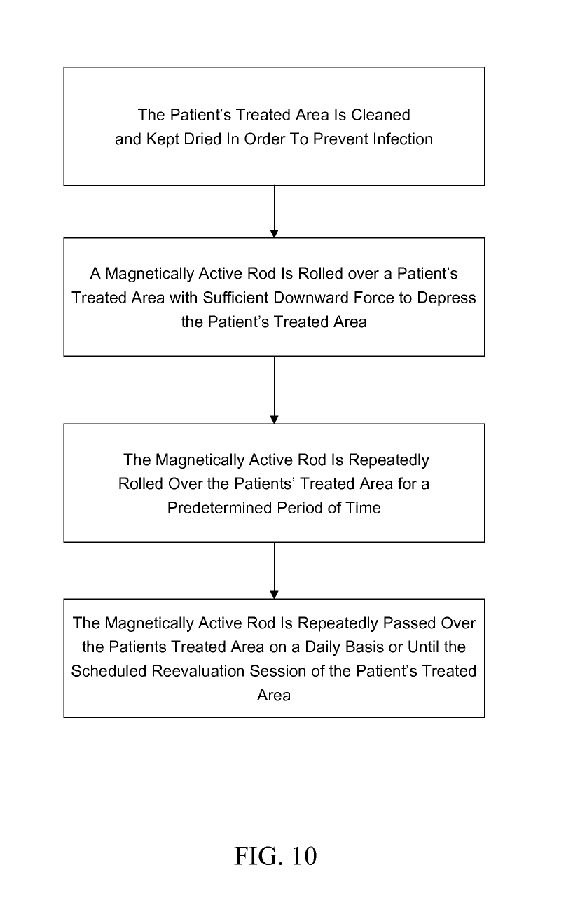

Referencing FIG. 8 and FIG. 10, in another embodiment of the present invention, the administration of the post-treatment protocol utilizes a magnetically active rod. In the post-treatment protocol comprises the steps of rolling the magnetically active rod over the patient's treated area with sufficient downward force to depress the patients' treated area; repeating the action of rolling the magnetically active rod over the patient's treated area for a predetermined period of time; and repeating the action of the passing the magnetically active rod over the patient's treated area for a predetermined period of time on a daily basis until the date of the scheduled reevaluation session of the patient's treated area. The magnetically active rod is provided as a means of mechanically depressing the patient's treatable area, disrupting the positioning of magnetically active pigments or dyes that are found in the treated area. By repeatedly rolling the magnetically active rod over the treated area for a predetermined period of time, a larger quantity of magnetically active pigments and dyes can be loosened up facilitating the removal through the magnetically assisted dermatological procedure. It should be noted that the predetermined period of time would be a provided value associated with the size and location of the patient's treatable area. It should be noted that the magnetically active rod may be constructed using integrally positioned rare earth magnets, such as neodymium magnets, but could additionally utilize an electromagnet.

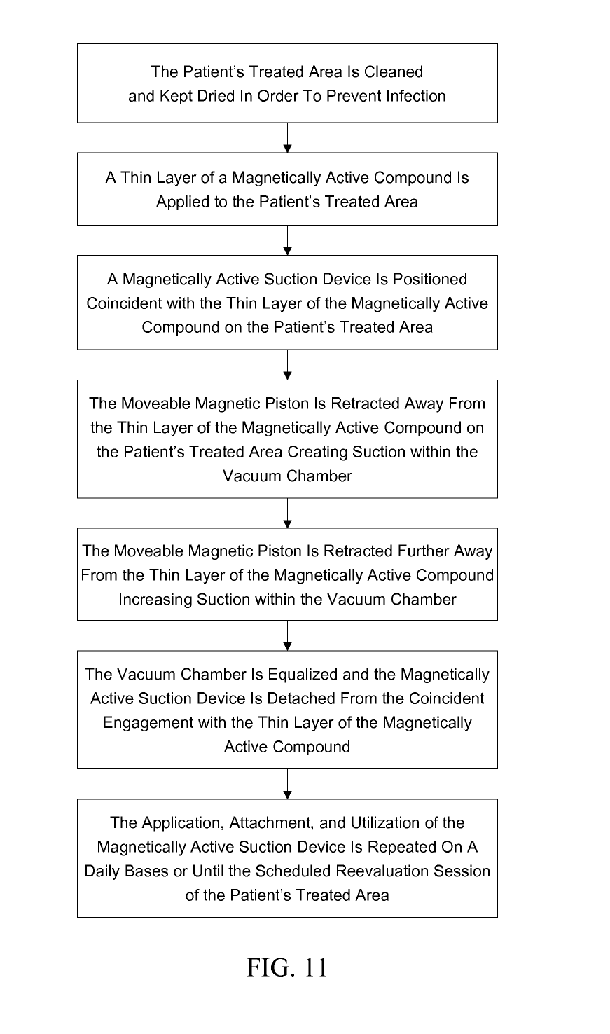

Referencing FIG. 8 and FIG. 11, in yet another embodiment of the present invention, the post-treatment protocol utilizes a magnetically active suction device in combination with the magnetically active compound as a means of improving the resolution of the patient's treatable condition following the administration of the magnetically active dermatological procedure. The magnetically active suction device comprises a vacuum chamber and a moveable magnetic piston. The magnetically active suction device comprises a vacuum chamber and a moveable magnetic piston. The vacuum chamber is the interior portion of the magnetically active suction device that increases or decreases in pressure depending on the positioning of the moveable magnetic piston. The moveable magnetic piston functions as a plunger that is peripherally coincident with the inner walls of the vacuum chamber forming an air tight seal. When the vacuum chamber is sealed against the patient's treated area, the moveable magnetic piston creates an area of negative pressure when retracted within vacuum chamber. It should be noted that the moveable magnetic piston is held in place when retracted through a nonspecific mechanism within the magnetically active suction device which could be accomplished. In the current embodiment of the present invention the administration of the post-treatment protocol comprises the steps of applying a thin layer of the magnetically active compound to the patient's treated area; positioning the magnetically active suction device coincident with the thin layer of the magnetically active compound on the patient's treated area; creating suction in the vacuum chamber by retracting the moveable magnetic piston away from the thin layer of the magnetically active compound on the patient's treated area; increasing the suction within the vacuum chamber by retracting the moveable magnetic piston further from the thin layer of the magnetically active compound on the patient's treated area; removing the magnetically active suction device from the coincident positioning with the thin layer of the magnetically active compound on the patient's treated area after a predetermined period of time; repeating the above actions on a daily basis until the scheduled reevaluation session for the patient' treated area.

Referencing FIG. 8 and FIG. 11, the application of the thin layer of the magnetically active compound on the patient's treated area is provided as a magnetic compound and as a sealant for securing the magnetically active suction device to the patient's treated area. The magnetically active suction device is positioned coincident with the magnetically active compound on the patient's treated area forming an air tight seal for the vacuum chamber. The creation of suction within the vacuum chamber occurs upon retracting the moveable magnetic piston further into the vacuum chamber. The moveable magnetic piston is retracted away from the magnetically active compound positioned on top of the patient's treated area resulting in an area of negative pressure forming within the vacuum chamber. It should be noted that in the current embodiment of the present invention, the moveable magnetic piston utilizes a rare-earth magnet that is provided with the north side facing towards the thin layer of the magnetically active compound on the patient's treated area, but that in additional embodiments, the moveable magnetic piston could potentially utilize an electromagnet in the same capacity. After suction is created within the vacuum chamber, the magnetically active suction device is maintained on the patient's treated area for a predetermined period of time, wherein the predetermined period of time is approximately a 10 minute interval. Upon completion of the predetermined period of time, the negative pressure within the suction chamber is increased by further retracting the moveable magnetic piston within the vacuum chamber. The suction within vacuum chamber is increased several times during the administration of the post-treatment protocol after which the pressure within the vacuum chamber is equalized and the magnetically active suction device is removed from its position coincident with the thin layer of the magnetically active compound on the patient's treated area. The administration of the post-treatment protocol is repeated on a daily basis until the date of the scheduled reevaluation session of the patient's treated area. It should be noted that while the magnetically active suction device, in the additional embodiment, utilizes a moveable magnetic piston, that in an alternative embodiment, the moveable magnetic piston can be omitted providing the magnetically active suction device as any suction device or system that generates suction within the vacuum chamber.

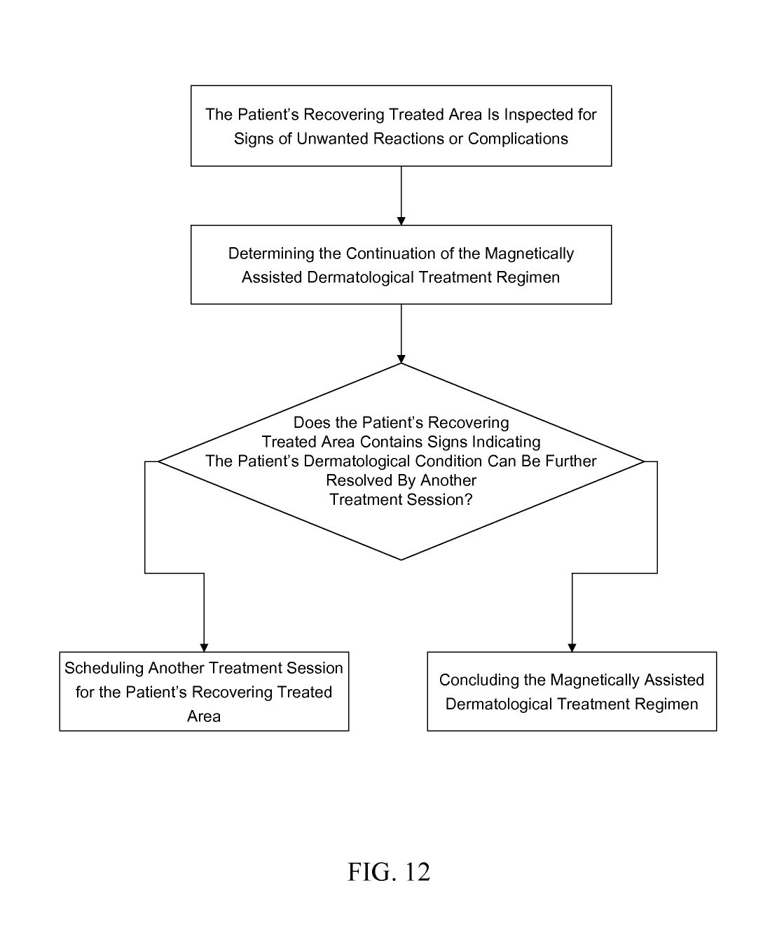

Referencing FIG. 1 and FIG. 12, the step of reevaluating the patient is provided as a verification step that determines the success of a treatment session of the magnetically assisted dermatological procedure. In the reevaluation step, a decision scheme is used to make a determination if the patient's treated area is to be scheduled for another treatment session of the magnetically assisted dermatological procedure or if the magnetically assisted dermatological treatment regimen is to be concluded based on resolution of the patient's dermatological condition. In the current embodiment of the present invention, the reevaluation step is provided with an understanding that the patient's dermatological condition comprises a recovering treated area. The recovering treated area is the treated area that has undergone the post-treatment protocol. The reevaluation step further comprises the steps of inspecting the patient's recovering treated area for signs of unwanted reactions or complications; scheduling another treatment session for the patient's recovering treated area, if the patient's recovering treated area contains signs indicating the patient's dermatological condition can be further resolved by another treatment session of the magnetically assisted dermatological procedure; or concluding the magnetically assisted dermatological treatment regimen, if the patient's recovering treated area shows signs indicating the patient's dermatological condition has been resolved.

Referencing FIG. 1 and FIG. 12, the inspection of the patient's recovering treated area is provided as a step that ensures that the patient's recovering treated area is properly healing and is not showing any signs of unwanted reactions or complications. Due to the nature of the magnetically assisted dermatological procedure being a photothermolytic procedure, the patient's recovering treated area is healing from what is essentially a superficial burn wound. Immediately following the administration of the magnetically assisted dermatological procedure treatment session, the patient's recovering treated area is susceptible to infections if not properly cared for. The inspection step ensures that the patient has been adhering to the post-treatment protocol as well as making sure that if any complications have arisen that an appropriate treatment plan can be instituted to ensure the patient's safety.

Referencing FIG. 1 and FIG. 12, the inspection of the patients' recovering treated area is additionally utilized to determine if the patient's dermatological condition has been resolved during the treatment session of the magnetically assisted dermatological procedure or if the patient's dermatological condition can be further resolved by the another treatment session of the magnetically assisted dermatological procedure. The determination is based on the inspection of the patient's recovering treated area and an assessment that indicates that the patient's dermatological condition has been resolved or unresolved based on indicative signs present in the patient's dermatological condition. The indicative signs would be dependent on the patient's dermatological condition but would most generally be understood as noticeable reduction in the presence of the pigments and dyes found in the patient's recovering treated area.

If the recovering treated area does not show a noticeable reduction of the pigments and dyes of the patient's dermatological condition, a determination could be made that another treatment session of the magnetically assisted dermatological procedure should be administered in order to improve the resolution of the patient's dermatological condition. This determination would lead to the scheduling of another treatment session for the patient's recovering treated area. Upon scheduling the another treatment session for the patient's recovering treated are, the post treatment protocol would function as the pre-treatment protocol for another treatment session of the magnetically assisted dermatological procedure. It should be noted that the specific post-treatment protocol utilized in the previous treatment session can be differentiated from the pre-treatment protocol utilized in the next treatment session if desired. If the recovering treated area shows noticeable reduction of pigments and dyes found on the patient's dermatological condition, it would be determined that the patient's dermatological condition has been sufficiently resolved and the magnetically assisted treatment regimen could concluded. This determination would lead to no further scheduling of treatment sessions for the patients' recovering treated area and could additionally include an instruction set for continuing or ending the post treatment protocol after a predetermined period of time.

In the current embodiment of the present invention, the magnetically assisted light emitting apparatus is a laser phototherapy instrument that could operate at a variety of wavelengths, and power levels contains a magnetically active component in order to assist in the removal of pigments and inks. While the exact laser phototherapy instrument is not explicitly described in the current embodiment of the present invention, it should be noted that the treatment modality that is the laser phototherapy instrument could potentially be any of the plurality of laser phototherapy instruments that are currently utilized for the purposes of tattoo removal and treatment of pigmented dermatological conditions. these laser phototherapy instruments include but are not limited to Q-switched ND:YAG lasers operating at 1064 nm, Q-switched alexandrite lasers operating at 755 nm, Intense pulse light (IPL) light emitting instruments that emit wavelengths in between 500 nm and 1200 nm, as well as other light emitting instruments that is currently utilized in photothermolytic therapies for the removal of tattoos. Although the specific modality of the laser phototherapy instrument could be accomplished by any number of modalities, it should be noted that the specific modality should be able to function with a magnetic component positioned adjacent to the aperture.

In the current embodiment of the present invention, the magnetically assisted dermatological procedure is administered by a non-specific entity. Although the current embodiment of the present invention does not specifically mention the entity that administers the magnetically assisted dermatological treatment method, it should be noted that the omission was intentional. Preferably, the magnetically assisted dermatological procedure is administered by an individual who is a trained clinician in sterile clinical conditions, but with safety advances in the treatment modalities it is possible that the treatment procedure could potentially be administered by the patient in their own homes as long as safety precautions were followed.

In the current embodiment of the present invention, the pre-treatment protocol and the post-treatment protocol are provided as supplementary processes that assist the magnetically assisted dermatological treatment in the resolution of a patient's dermatological condition. While both the pre-treatment protocol and the post-treatment protocol assist in the resolution of the patient's dermatological treatment, it should be noted that in an alternative embodiment, both the pre-treatment protocol and the post-treatment protocol could potentially be utilized by themselves as a means of resolving a patient's dermatological condition. In this alternative embodiment, the administration of the pre-treatment or post-treatment protocol would serve the function as the magnetically assisted dermatological procedure.

In the current embodiment of the present invention, the magnetic compound is provided as a negatively charged aluminium phyllosilicate paste that is commonly known as bentonite clay. While the specific charge properties of the aluminum phyllosilicate paste are not explicitly described, it should be noted that the composition of the aluminium phyllosilicate paste is provided with stable charge properties. the aluminium phyllosilicate paste is a colloidal suspension whose charge properties are partially dependent on the ionic strength and pH of a solution. It was observed from potentiometric titrations that a zero net proton adsorption occurred at about pH 8.2 (pH_{PNZPC}˜8.2). Surface charges of the Aluminium phyllosilicate colloids mainly carrying structural negative charges revealed a very small dependency on the pH. With this knowledge the current embodiment of the present invention utilizes a quantity of apple cider in order to create the aluminium phyllosilicate coilloid solution. the aluminium phyllosilicate colloid solution that incorporates apple cider has a lower pH resulting in better charge stability for using the magnetically assisted dermatological treatment regimen.

In an additional embodiment, the present invention would be utilized as part of a system that would permit individuals from using specially formulated tattoo ink that would be easily removed through the magnetically assisted dermatological treatment regimen. The easily removable tattoo inks would specially formulated to include higher levels of iron oxide instead of non-ferrous based dyes in order to facilitate removal if sought by the patient.

In an additional embodiment of the present invention, the magnetically assisted dermatological procedure may substitute the magnetically assisted light emitting apparatus for an alternative treatment regimen that utilizes the magnetically assisted suction device and the application of a heated resin to the patient's treatable area in order to provide a non photothermal option for removing the patient's tattoo. In the additional embodiment of the present invention, the alternative treatment modality would comprises the steps of applying a thin layer of the magnetically active compound to the patient's treatable area. Followed by the attachment of the magnetically active suction device to the thin layer of the magnetically active compound. With the magnetically active suction device in place, negative pressure within the vacuum chamber would be increased through the retraction of the moveable magnetic piston. The moveable magnetic piston would be retracted every 10 minutes over the course of 30 minutes. After 30 minutes, the magnetically active suction device would be detached from the patient's treatable area. The treatable area would be sprayed with a blend of peppermint, tea tree, and lemon oil, which have been certain properties that benefit tattoo removal. After the blend has been applied to the treatable area, a low temperature hot glue gun would apply a tattoo removal resin that is specially designed for the removal of tattoos. The tattoo removal resin would be applied at 180 degrees and would infuse with the blend. The low heat provided by the tattoo removal resin act as an agent that produces a low thermal injury to the treatable area, disrupting pigments and dyes. The tattoo removal resin would cool within 10-20 second after which it would be removed. The process of applying the tattoo removal resin would be provided in three successive applications to the same section of the patient's treatable area prior to administration on another section of the patient's treatable area. Once all sections of the patient's treatable area have been treated with the tattoo removal resin, another thin layer of the magnetically active compound is applied to the patient's treatable area as well as the administration of the magnetically active suction device. The entirety of the process is repeated until the tattoo has faded. It should be noted that aforementioned process could potentially utilize the blend as part of both the post-treatment and pre-treatment protocols.

Although the invention has been explained in relation to its preferred embodiment, it is to be understood that many other possible modifications and variations can be made without departing from the spirit and scope of the invention as hereinafter claimed.

What is claimed is:

1. A magnetically assisted dermatological treatment regimen comprises the steps of:
providing a magnetically assisted dermatological treatment regimen comprises a pre-treatment protocol, a magnetically assisted dermatological procedure, and a post-treatment protocol;
providing a patient's dermatological condition;
providing a magnetically active compound;
evaluating the patient seeking the magnetically assisted dermatological treatment regimen;
initiating the pre-treatment protocol;
administering a treatment session of the magnetically assisted dermatological procedure;
initiating the post-treatment protocol; and
reevaluating the patient after the post-treatment protocol.

2. The magnetically active compound as claimed in claim 1 consists of a negatively charged aluminium phyllosilicate paste.

3. The step of evaluating the patient seeking the magnetically assisted dermatological treatment regimen as claimed in claim 1 comprises the steps of:
evaluating the patient's medical history for contraindicated conditions;
inspecting the patient's dermatological condition; and
scheduling the magnetically assisted dermatological treatment regimen for the patients dermatological condition.

4. The step of initiating the pre-treatment protocol as claimed in claim 1 comprises the steps of:
providing the patient's dermatological condition as a treatable area for the administration of the pre-treatment protocol;
preparing the patient's treatable area for administration of the pre-treatment protocol; and
administering the pre-treatment protocol to the patient's treatable area.

5. The step of administering the pre-treatment protocol as claimed in claim 4 further comprises the steps of:
applying a thin layer of the magnetically active compound to the patient's treatable area;
maintaining the thin layer of the magnetically active compound on the patient's treatable area for at least one hour; and
repeating the action of applying the thin layer of the magnetically active and maintaining said thin layer of the magnetically active compound on the patient's treatable area for at least one hour, on a daily basis, until the scheduled treatment session of the magnetically assisted dermatological procedure.

6. The step of administering the pre-treatment protocol as claimed in claim 4 further comprises the steps of:
providing a magnetically active rod;
rolling the magnetically active rod over the patient's treatable area, wherein the magnetically active rod is rolled over the patient's treatable area with sufficient downward force to depress the patient's treatable area;
repeating the action of rolling the magnetically active rod over the patient's treatable area for a predetermined period of time; and
repeating the action of the passing the magnetically active rod over the patient's treatable area for a predetermined period of time, on a daily basis, until the scheduled treatment session of the magnetically assisted dermatological procedure.

7. The step of administering the pre-treatment protocol as claimed in claim 4 further comprises the steps of:
providing a magnetically active suction device comprising a vacuum chamber and a moveable magnetic piston, wherein the moveable magnetic piston is sleeved by the vacuum chamber;
applying a thin layer of the magnetically active compound to the patient's treatable area;
positioning the magnetically active suction device coincident with the thin layer of the magnetically active compound on the patient's treatable area, wherein the placement of the magnetically active suction device on the thin layer of the magnetically active compound permits the vacuum chamber to form an air tight seal with the patient's treatable area;
creating suction in the vacuum chamber by retracting the moveable magnetic piston away from the thin layer of the magnetically active compound on the patient's treatable area;
increasing suction within the vacuum chamber by retracting the moveable magnetic piston further from the thin layer of the magnetically active compound on the patient's treatable area, wherein the moveable magnetic piston is retracted further once every 10 minutes;
removing the magnetically active suction device from the coincident positioning with the thin layer of the magnetically active compound on the patient's treatable area after a predetermined period of time, wherein pressure within the vacuum chamber is equalized in order to remove the magnetically active suction device; and
repeating the actions of applying the thin layer of the magnetically active compound, positioning the magnetically active suction device, creating suction in the vacuum chamber, increasing suction within the vacuum chamber, and removing the magnetically active suction device for the positioning with the thin layer of the magnetically active compound on the patient's treatable area, on a daily basis, until the scheduled treatment session of the magnetically assisted dermatological procedure.

8. The step of administering the treatment session of the magnetically assisted dermatological procedure as claimed in claim 1 comprises the steps of:
providing a magnetically assisted light emitting apparatus comprising an aperture and a magnetically active ring, wherein the aperture functions as the opening from which light is emitted and the magnetically active ring is found encircling the aperture;
providing the patient's dermatological condition as a treatable area for the administration of a treatment session of the magnetically assisted dermatological procedure, wherein the treatable area is subdivided into sections;
preparing the patient's treatable area for the treatment session of the magnetically assisted dermatological procedure;
positioning the aperture coincident with a section of the patient's treatable area;
activating the magnetically assisted light emitting apparatus on the section of the patient's treatable area;
maintaining the activated magnetically assisted light emitting apparatus on the section of the patient's treatable area for a predetermined period of time, wherein the predetermined period of time ranges from 10 to 45 seconds;
repositioning the aperture coincident with another section of the patient's treatable area; and
repeating the actions of activating the magnetically assisted light emitting apparatus on the section of the patient's treatable area, maintaining the magnetically assisted light emitting apparatus on the section of the patient's treatable area for the predetermined period of time, and repositioning the aperture coincident with another section of the patient's treatable area, until all sections of the patient's treatable area have been coincident with the aperture.

9. The step of initiating the post-treatment protocol as claimed in claim 1 comprises the steps of:
providing the patient's dermatological condition as a treated area following the administration of a treatment session of the magnetically assisted dermatological procedure;
providing a scheduled reevaluation session of the patient's treated area;
maintaining the treated area clean and dry to prevent infection; and
administering the post-treatment protocol to the patient's treated area.

10. The step of administering the post -treatment protocol as claimed in claim 9 further comprises the steps of:
applying a thin layer of the magnetically active compound to the patient's treated area;
maintaining the thin layer of the magnetically active compound on the patient's treated area for at least one hour; and
repeating the action of applying the thin layer of the magnetically active and maintaining said thin layer of the magnetically active compound on the patient's treated area for at least one hour, on a daily basis, until the scheduled reevaluation session of the patient's treated area.

11. The step of administering the post -treatment protocol as claimed in claim 9 further comprises the steps of:
providing a magnetically active rod;
rolling the magnetically active rod over the patient's treated area, wherein the magnetically active rod is rolled over the patient's treated area with sufficient downward force to depress the patient's treated area;
repeating the action of rolling the magnetically active rod over the patient's treated area for a predetermined period of time; and
repeating the action of the passing the magnetically active rod over the patient's treated area for a predetermined period of time, on a daily basis, until the scheduled reevaluation session of the patient's treated area.

12. The step of administering the post-treatment protocol as claimed in claim 9 further comprises the steps of:
providing a magnetically active suction device comprising a vacuum chamber and a moveable magnetic piston, wherein the moveable magnetic piston is sleeved by the vacuum chamber;
applying a thin layer of the magnetically active compound to the patient's treated area;
positioning the magnetically active suction device coincident with the thin layer of the magnetically active compound on the patient's treated area, wherein the placement of the magnetically active suction device on the thin layer of the magnetically active compound permits the vacuum chamber to form an air tight seal with the patient's treated area;
creating suction in the vacuum chamber by retracting the moveable magnetic piston away from the thin layer of the magnetically active compound on the patient's treated area;
increasing suction within the vacuum chamber by retracting the moveable magnetic piston further from the thin layer of the magnetically active compound on the patient's treated area, wherein the moveable magnetic piston is retracted further once every 10 minutes;
removing the magnetically active suction device from the coincident positioning with the thin layer of the magnetically active compound on the patient's treated area after a predetermined period of time, wherein pressure within the vacuum chamber is equalized in order to remove the magnetically active suction device; and
repeating the actions of applying the thin layer of the magnetically active compound, positioning the magnetically active suction device, creating suction in the vacuum chamber, increasing suction within the vacuum chamber, and removing the magnetically active suction device for the positioning with the thin layer of the magnetically active compound on the patient's treated area, on a daily basis, until the scheduled reevaluation session of the patient's treated area.

13. The step of reevaluating the patient after the post-treatment protocol as claimed in claim 1 comprises the steps of:
providing the patient's dermatological condition as a recovering treated area for a scheduled reevaluation session following the administration of the post-treatment protocol;
inspecting the patient's recovering treated area for signs of unwanted reactions or complications;
scheduling another treatment session for the patient's recovering treated area,
if the patient's recovering treated area contains signs indicating the patient's dermatological condition can be further resolved by another treatment session of the magnetically assisted dermatological procedure; and
concluding the magnetically assisted dermatological treatment regimen,
if the patient's recovering treated area contains signs indicating the patient's dermatological condition cannot be further resolved by another treatment session of the magnetically assisted dermatological procedure.

14. A magnetically assisted dermatological treatment regimen comprises the steps of:
providing a magnetically assisted dermatological treatment regimen comprises a pre-treatment protocol, a magnetically assisted dermatological procedure, and a post-treatment protocol;
providing a patient's dermatological condition;
providing a magnetically active compound, wherein the magnetically active compound consists of a negatively charged aluminium phyllosilicate paste;
providing the patient's dermatological condition as a treatable area for the administration of the pre-treatment protocol;
providing a magnetically assisted light emitting apparatus comprising an aperture and a magnetically active ring, wherein the aperture functions as the opening from which light is emitted and the magnetically active ring is found encircling the aperture;
providing the patient's dermatological condition as a treatable area for the administration of a treatment session of the magnetically assisted dermatological procedure, wherein the treatable area is subdivided into sections;
providing the patient's dermatological condition as a treated area following the administration of a treatment session of the magnetically assisted dermatological procedure;
providing a scheduled reevaluation session of the patient's treated area;
providing the patient's dermatological condition as a recovering treated area for a scheduled reevaluation session following the administration of the post-treatment protocol;
evaluating the patient's medical history for contraindicated conditions;
inspecting the patient's dermatological condition;
scheduling the magnetically assisted dermatological treatment regimen for the patients dermatological condition;
preparing the patient's treatable area for administration of the pre-treatment protocol;
administering the pre-treatment protocol to the patient's treatable area;
preparing the patient's treatable area for the treatment session of the magnetically assisted dermatological procedure;
positioning the aperture coincident with a section of the patient's treatable area;
activating the magnetically assisted light emitting apparatus on the section of the patient's treatable area;
maintaining the activated magnetically assisted light emitting apparatus on the section of the patient's treatable area for a predetermined period of time, wherein the predetermined period of time ranges from 10 to 45 seconds;
repositioning the aperture coincident with another section of the patient's treatable area;
repeating the actions of activating the magnetically assisted light emitting apparatus on the section of the patient's treatable area, maintaining the magnetically assisted light emitting apparatus on the section of the patient's treatable area for the predetermined period of time, and repositioning the aperture coincident with another section of the patient's treatable area, until all sections of the patient's treatable area have been coincident with the aperture;
maintaining the treated area clean and dry to prevent infection;
administering the post-treatment protocol to the patient's treated area;
inspecting the patient's recovering treated area for signs of unwanted reactions or complications;
determining the continuation of the magnetically assisted dermatological treatment regimen;
scheduling another treatment session for the patient's recovering treated area,
if the patient's recovering treated area contains signs indicating the patient's dermatological condition can be further resolved by another treatment session of the magnetically assisted dermatological procedure; and
concluding the magnetically assisted dermatological treatment regimen, if the patient's recovering treated area contains signs indicating the patient's dermatological condition cannot be further resolved by another treatment session of the magnetically assisted dermatological procedure.

15. The step of administering the pre-treatment protocol as claimed in claim 14 further comprises the steps of:
applying a thin layer of the magnetically active compound to the patient's treatable area;
maintaining the thin layer of the magnetically active compound on the patient's treatable area for at least one hour;
repeating the action of applying the thin layer of the magnetically active and maintaining said thin layer of the magnetically active compound on the patient's treatable area for at least one hour, on a daily basis, until the scheduled treatment session of the magnetically assisted dermatological procedure;

16. The step of administering the pre-treatment protocol as claimed in claim 14 further comprises the steps of:
providing a magnetically active rod;
rolling the magnetically active rod over the patient's treatable area, wherein the magnetically active rod is rolled over the patient's treatable area with sufficient downward force to depress the patient's treatable area;
repeating the action of rolling the magnetically active rod over the patient's treatable area for a predetermined period of time;
repeating the action of the passing the magnetically active rod over the patient's treatable area for a predetermined period of time, on a daily basis, until the scheduled treatment session of the magnetically assisted dermatological procedure;

17. The step of administering the pre-treatment protocol as claimed in claim 14 further comprises the steps of:
providing a magnetically active suction device comprising a vacuum chamber and a moveable magnetic piston, wherein the moveable magnetic piston is sleeved by the vacuum chamber;
applying a thin layer of the magnetically active compound to the patient's treatable area;
positioning the magnetically active suction device coincident with the thin layer of the magnetically active compound on the patient's treatable area, wherein the placement of the magnetically active suction device on the thin layer of the magnetically active compound permits the vacuum chamber to form an air tight seal with the patient's treatable area;
creating suction in the vacuum chamber by retracting the moveable magnetic piston away from the thin layer of the magnetically active compound on the patient's treatable area;
increasing suction within the vacuum chamber by retracting the moveable magnetic piston further from the thin layer of the magnetically active compound on the patient's treatable area, wherein the moveable magnetic piston is retracted further once every 10 minutes;
removing the magnetically active suction device from the coincident positioning with the thin layer of the magnetically active compound on the patient's treatable area after a predetermined period of time, wherein pressure within the vacuum chamber is equalized in order to remove the magnetically active suction device;
repeating the actions of applying the thin layer of the magnetically active compound, positioning the magnetically active suction device, creating suction in the vacuum chamber, increasing suction within the vacuum chamber, and removing the magnetically active suction device for the positioning with the thin layer of the magnetically active compound on the patient's treatable area, on a daily basis, until the scheduled treatment session of the magnetically assisted dermatological procedure;

18. The step of administering the post -treatment protocol as claimed in claim 14 further comprises the steps of:
applying a thin layer of the magnetically active compound to the patient's treated area;
maintaining the thin layer of the magnetically active compound on the patient's treated area for at least one hour;
repeating the action of applying the thin layer of the magnetically active and maintaining said thin layer of the magnetically active compound on the patient's treated area for at least one hour, on a daily basis, until the scheduled reevaluation session of the patient's treated area;

19. The step of administering the post-treatment protocol as claimed in claim 14 further comprises the steps of:
providing a magnetically active rod;
rolling the magnetically active rod over the patient's treated area, wherein the magnetically active rod is rolled over the patient's treated area with sufficient downward force to depress the patient's treated area;
repeating the action of rolling the magnetically active rod over the patient's treated area for a predetermined period of time;
repeating the action of the passing the magnetically active rod over the patient's treated area for a predetermined period of time, on a daily basis, until the scheduled reevaluation session of the patient's treated area;

20. The step of administering the post-treatment protocol as claimed in claim 14 further comprises the steps of:
providing a magnetically active suction device comprising a vacuum chamber and a moveable magnetic piston, wherein the moveable magnetic piston is sleeved by the vacuum chamber;
applying a thin layer of the magnetically active compound to the patient's treated area;
positioning the magnetically active suction device coincident with the thin layer of the magnetically active compound on the patient's treated area, wherein the placement of the magnetically active suction device on the thin layer of the magnetically active compound permits the vacuum chamber to form an air tight seal with the patient's treated area;
creating suction in the vacuum chamber by retracting the moveable magnetic piston away from the thin layer of the magnetically active compound on the patient's treated area;
increasing suction within the vacuum chamber by retracting the moveable magnetic piston further from the thin layer of the magnetically active compound on the patient's treated area, wherein the moveable magnetic piston is retracted further once every 10 minutes;
removing the magnetically active suction device from the coincident positioning with the thin layer of the magnetically active compound on the patient's treated area after a predetermined period of time, wherein pressure within the vacuum chamber is equalized in order to remove the magnetically active suction device;
repeating the actions of applying the thin layer of the magnetically active compound, positioning the magnetically active suction device, creating suction in the vacuum chamber, increasing suction within the vacuum chamber, and removing the magnetically active suction device for the positioning with the thin layer of the magnetically active compound on the patient's treated area, on a daily basis, until the scheduled reevaluation session of the patient's treated area;
